(19) United States
(12) Patent Application Publication
(10) Pub. No.: US 2024/0143191 A1
(43) Pub. Date: May 2, 2024

(54) CYCLIC BACKUP METHOD AND RELATED SOLID-STATE DISK DEVICE

(71) Applicant: Apacer Technology Inc., New Taipei City (TW)

(72) Inventor: Yu-Che Lee, New Taipei City (TW)

(73) Assignee: Apacer Technology Inc., New Taipei City (TW)

(21) Appl. No.: 18/087,794

(22) Filed: Dec. 22, 2022

(30) Foreign Application Priority Data
Oct. 31, 2022 (TW) 111141322

(51) Int. Cl. G06F 3/06

(52) U.S. Cl. CPC G06F 3/0619; G06F 3/0659; G06F 3/0679

(57) ABSTRACT

A cyclic backup method for a solid-state disk (SSD) device includes writing, by a controller, data into corresponding physical address and reading data from corresponding physical address according to logic address of a first mapping table; receiving, by the controller, a backup signal; writing, by the controller, data into corresponding physical address and reading data from corresponding physical address according to logic address of a second mapping table; reading, by the controller, a first data according to logic address of the first mapping table when the controller cannot read the first data according to logic address of the second mapping table; receiving, by the controller, a recovery signal; and reading, by the controller, data from corresponding physical address according to logic address of the first mapping table.

### BACKGROUND OF THE INVENTION

### 1. Field of the Invention

The present invention relates to a cyclic backup method and a related solid-state disk device, and more particularly, to a cyclic backup method and related solid-state disk device capable of improving recovery efficiency.

### 2. Description of the Prior Art

When the conventional solid-state disk (SSD) is utilized as a storage device, most of them rely on settings of third-party software to select a data range for data backup or data recovery, and the settings are necessary to be reset each time. In this situation, the selection step of the data range might be neglected by the user after executing the data recovery, which causes failure of data recovery. In addition, a selected data range might not be able to cover the entire storage space of the storage device, which results in issues of time-consuming and bad efficiency of the conventional backup and recovery method of the SSD.

Therefore, improvements to the conventional technique are necessary.

### SUMMARY OF THE INVENTION

In light of this, the present invention provides a cyclic backup method and related solid-state disk device to improve recovery efficiency.

An embodiment of the present invention discloses a cyclic backup method for a solid-state disk (SSD) device, wherein the SSD device includes a controller and a storage space, the cyclic backup method comprises writing, by the controller, data into corresponding physical address and reading data from corresponding physical address according to logic address of a first mapping table; receiving, by the controller, a backup signal; writing, by the controller, data into corresponding physical address and reading data from corresponding physical address according to logic address of a second mapping table; reading, by the controller, a first data according to logic address of the first mapping table when the controller cannot read the first data according to logic address of the second mapping table; receiving, by the controller, a recovery signal; and reading, by the controller, data from corresponding physical address according to logic address of the first mapping table; wherein each logic address of the second mapping table depends on each logic address of the first mapping table.

Another embodiment of the present invention discloses acyclic backup method, for a solid-state disk (SSD) device, wherein the SSD device includes a controller and a storage space, the cyclic backup method comprises writing, by the controller, data into corresponding physical address and reading data from corresponding physical address according to logic address of a first mapping table; receiving, by the controller, a backup signal; writing, by the controller, data into corresponding physical address or reading data from corresponding physical address according to logic address of a second mapping table; reading, by the controller, a first data according to logic address of the first mapping table when the controller cannot read the first data according to logic address of the second mapping table; receiving, by the controller, a recovery signal; and writing, by the controller, data into corresponding physical address and reading data from corresponding physical address according to logic address of the first mapping table; wherein each logic address of the second mapping table depends on each logic address of the first mapping table.

Another embodiment of the present invention discloses a solid-state disk (SSD) device, comprises a storage space; and a controller, configured to perform a cyclic backup process according to instructions of a host system, wherein the cyclic backup process comprises writing, by the controller, data into corresponding physical address and reading data from corresponding physical address according to logic address of a first mapping table; receiving, by the controller, a backup signal; writing, by the controller, data into corresponding physical address and reading data from corresponding physical address according to logic address of a second mapping table; reading, by the controller, a first data according to logic address of the first mapping table when the controller cannot read the first data according to logic address of the second mapping table; receiving, by the controller, a recovery signal; and reading, by the controller, data from corresponding physical address according to logic address of the first mapping table; wherein each logic address of the second mapping table depends on each logic address of the first mapping table.

Another embodiment of the present invention discloses a solid-state disk (SSD) device, comprises a storage space; and a controller, configured to perform a cyclic backup process according to instructions of a host system, wherein the cyclic backup process comprises writing, by the controller, data into corresponding physical address and reading data from corresponding physical address according to logic address of a first mapping table; receiving, by the controller, a backup signal; writing, by the controller, data into corresponding physical address or reading data from corresponding physical address according to logic address of a second mapping table; reading, by the controller, a first data according to logic address of the first mapping table when the controller cannot read the first data according to logic address of the second mapping table; receiving, by the controller, a recovery signal; and writing, by the controller, data into corresponding physical address and reading data from corresponding physical address according to logic address of the first mapping table; wherein each logic address of the second mapping table depends on each logic address of the first mapping table.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a solid-state disk (SSD) device according to an embodiment of the present invention.

FIG. 2 is a schematic diagram of correspondence of mapping tables and physical addresses according to an embodiment of the present invention.

FIG. 3, FIG. 4 and FIG. 5 are schematic diagrams of a host system writing/reading data of a storage space according to an embodiment of the present invention.

FIG. 6 is a schematic diagram of a one-time backup and multiple-times recovery method according to an embodiment of the present invention.

FIG. 7 is a schematic diagram of assignments of the mapping tables of the one-time backup and multiple-times recovery method in FIG. 6 according to an embodiment of the present invention.

FIG. 8 is a schematic diagram of a multiple-times backup and multiple-times recovery method according to an embodiment of the present invention.

### DETAILED DESCRIPTION

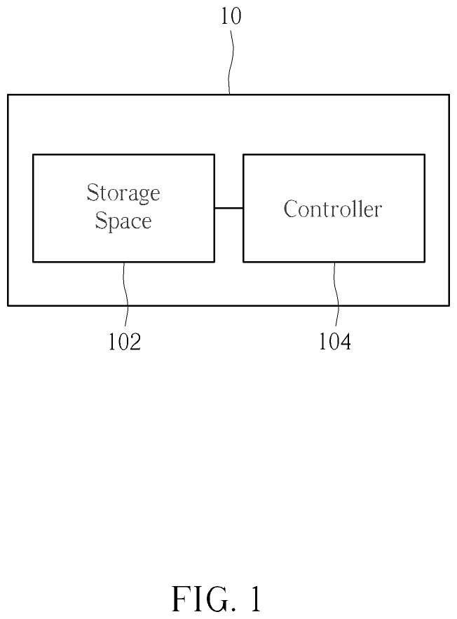

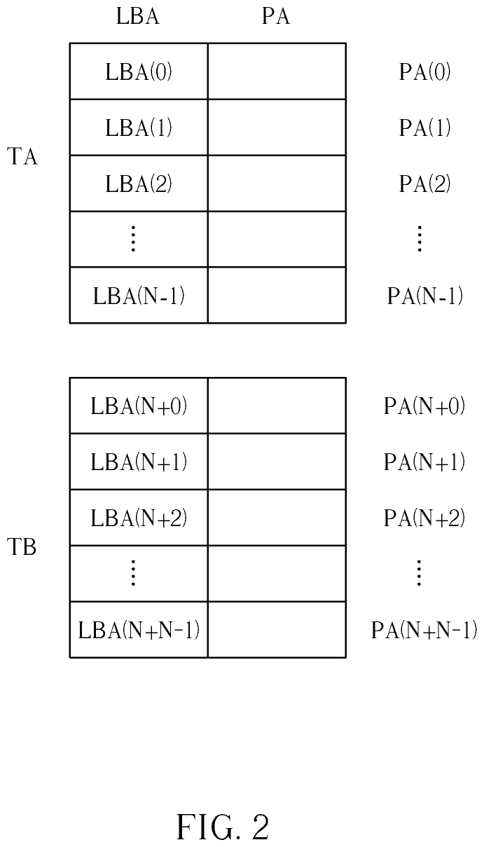

Please refer to FIG. 1, which is a solid-state disk (SSD) device 10 according to an embodiment of the present invention. The SSD device 10 may be a solid-state disk (SSD) for storing data. The SSD device 10 includes a storage space 102 and a controller 104, wherein the storage space 102 is an accessible memory space formed by NAND flash memory. In the present invention, the controller 104 may perform a cyclic backup process for the storage space 102 according to instructions of a host system (or a host), wherein the host system may access the storage space 102 for performing booting and other operations of data access.

In order to simplify user operation settings, an embodiment of the present invention utilizes conversions of mapping tables and physical addresses of the SSD device 10 to achieve rapid operations of data recovery and data backup. Since no file movements are necessary to the above conversions of mapping tables and physical addresses, a complexity of the data recovery and data backup operations is close to O(1). In addition, since the above operations are implemented by a controller, no third-party software is necessary for setting a data recovery range to achieve the data recovery in seconds by the SSD device 10 according to an embodiment of the present invention.

For further explanations, algorithms executed by a flash translation layer (FTL) of the SSD device 10 are important factors to affect the efficiency of the SSD device 10, which completes mappings from a space corresponding to a logical address used by the host system to a space corresponding to a physical address of the host system. That is, the SSD device 10 records the mapping relationship between the logic address and the physical address when the SSD device 10 writes logic data into the flash memory space. Then, when the host system is going to read the logic data next time, the SSD device 10 may read the data from the flash memory space according to the mapping relation to the host system, and the mapping relation is managed by maintaining a mapping table.

In the present invention, two mapping tables of the SSD device 110 are utilized for managing the storage space 102 of the SSD device 10, e.g. the storage space 102 is 1 TB, the mapping table TA and the mapping table TB of the SSD device 10 respectively manages half of the storage space 102, i.e. the mapping table TA and the mapping table TB respectively manages the storage space of 500 GB. In other words, a capacity of all physical addresses of the storage space 102 corresponding to logic addresses of the first mapping table TA is the same as a capacity of all physical addresses of the storage space 102 corresponding to logic addresses of the second mapping table TB. Notably, half of the storage space 102 of the SSD device 10 may be utilized by the user in this invention, and two mapping tables are utilized in the following embodiment of the present invention. In other embodiments, the SSD device 10 may include more than two mapping tables, which respectively manages the storage space 102, and is not limited to the number of the above embodiments.

In an example, assume that the mapping table TA is configured to manage logic addresses LBA(0)-LBA(N−1) of the storage space 102, wherein Nis an positive integer of storage unit of the storage space 102, the mapping table TB is configured to manage logic addresses LBA(N+0)-LBA(N+N−1) of the storage space 102. Since each of the logic addresses LBA corresponds to an independent physical address (PA) of the storage space 102, the host system may write data into corresponding physical address (PA) through the controller 104 according to the mapping table TA or the mapping table TB.

In the present invention, N storage units exist in logic location between the mapping table TA and the mapping table TB, and the logic addresses of the mapping table TA and the mapping table TB are mutually corresponded. The following are explanations of correspondence between the mapping table TA and the mapping table TB.

Please refer to FIG. 2, which is a schematic diagram of correspondence of the mapping tables TA, TB and the physical addresses PA according to an embodiment of the present invention. As shown in FIG. 2, the logic addresses LBA(0)-LBA(N−1) of the mapping table TA may be corresponded to physical addresses PA(0)-PA(N−1), and the logic addresses LBA(N+0)-LBA(N+N−1) of the mapping table TB may be corresponded to physical addresses PA(N+0)-PA(N+N−1) of the storage space 102.

Notably, each of the physical addresses PA corresponds to a logic location of the storage space 102 and is irrelevant to an order of the physical addresses PA(0)-PA(N+N−1). The storage space corresponded to the physical address PA is determined by a firmware algorithm of the SSD device 10, and the determined storage space is a better storage space to store data, e.g. the physical address PA(0) corresponds to a fifth storage unit of the storage space 102, the physical address PA(1) corresponds to a tenth storage unit of the storage space 102, and the correspondence between the logic address and the physical address is a conventional technique in the field of SSD and is not narrated herein again for brevity.

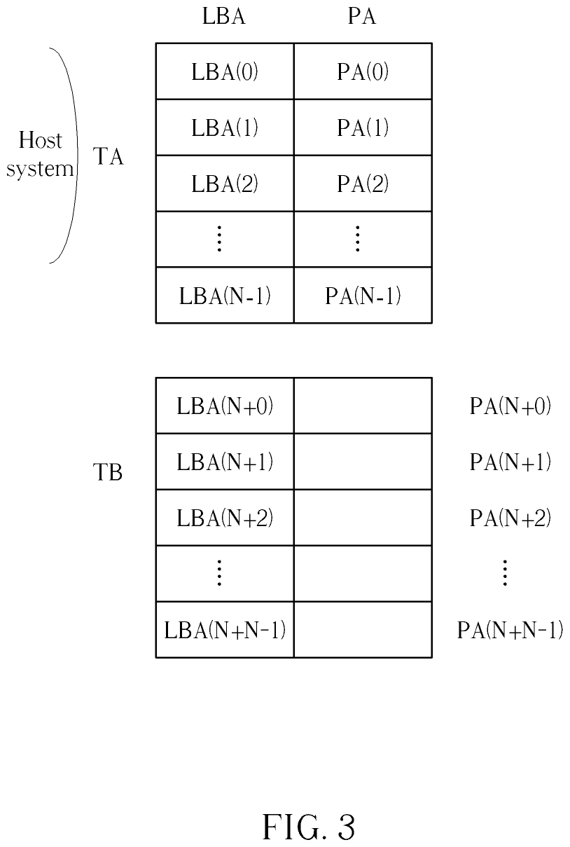

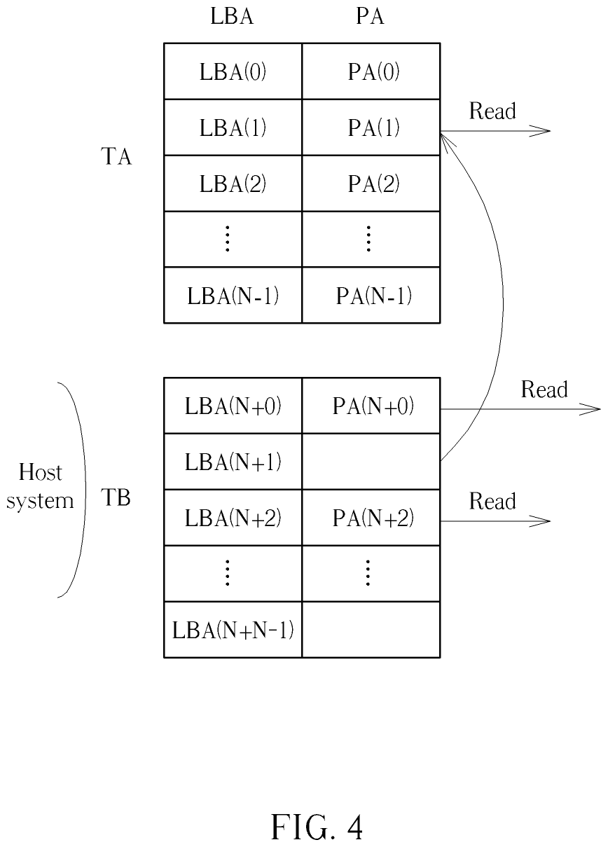

Please refer to FIG. 3, which is a schematic diagram of the host system 10 writing/reading data of the SSD device 10 according to an embodiment of the present invention. In an initial stage, the host system only reads/writes data through the mapping table TA. When the host system is going to write data into the SSD device 10, the controller 104 writes the data into the physical address PA corresponding to the mapping table TA and informs the host system about the corresponding logic address LBA of the physical address PA. When the host system is going to read the data, the host system may inform the controller 104 according to the logic address LBA and the controller 104 may access the data according to the physical address PA mapped from the logic address LBA. For example, in the initial stage, the host system may write data into corresponding physical addresses PA(0)-PA(N−1) according to the logic addresses LBA(0)-LBA(N−1) of the mapping table TA, and read data from the physical addresses PA(0)-PA(N−1) according to the logic addresses LBA(0)-LBA(N−1) of the mapping table TA.

In the present invention, when a condition of the storage space corresponding to the mapping table TA is satisfied, a backup mechanism is triggered and a backup signal is generated. After the controller 104 receives the backup signal, the controller 104 keeps all data of the physical addresses PA(0)-PA(N−1) corresponding to the mapping table TA without other writing operations, wherein the condition may be determined by the user, e.g. the backup signal is generated regularly for the SSD device or the backup signal is generated by the user.

Furthermore, in the present invention, the above backup mechanism may be triggered by a software method or a hardware method, e.g. an indication of backup mechanism triggered by a user through a third-party software or a button of the SSD device 10 is pressed by the user to trigger a physical signal and the physical signal is electrically transmitted to a general-purpose input/output (GPIO) pin of the controller 104, such that the controller 104 receives the physical signal, i.e. the backup signal, the above triggering method is an example, and not limited thereto.

In this situation, once the host system requests to write/read data, the controller 104 switches to the mapping table TB to read/write data. That is, after the controller 104 receives the backup signal, the controller 104 writes data into corresponding physical addresses PA(N+0)-PA(N+N−1) or reads data from corresponding physical addresses PA(N+0)-PA(N+N−1) according to the logic addresses LBA(N+0)-LBA(N+N−1) of the mapping table TB, as shown in FIG. 4.

Notably, after the controller 104 receives the backup signal, if a storage space corresponding to the logic address of the mapping table TB is an effective physical address, the controller 104 may read data corresponding to the physical address according to the mapping table TB; in contrast, when the storage space corresponding to the logic address of the mapping table TB is not an effective physical address, the controller 104 reads data corresponding to the physical address according to the logic addresses of the mapping table TA. Since the logic addresses of the mapping table TA and the mapping table TB are mutually corresponded, when the logic address of the mapping table TB is not an effective physical address, the controller 104 swifts N units of the logic address, which is already known, to read the data corresponding to the physical address according to the logic address of the mapping table TA. For example, when the physical address corresponding to the logic address LBA (N+1) of the mapping table TB is not an effective physical address, the controller 104 swifts N units of the logic address to the mapping table TA and reads data according to the logic address LBA(1) of the mapping table TA.

As shown in FIG. 5, the SSD device 10 according to an embodiment of the present invention erases data corresponding to the physical address of the mapping table TB according to a recovery signal. Then, the controller 104 swifts N units of the logic address to the mapping table TA and reads data from corresponding physical address according to the logic addresses of the mapping table TA. The data read by the controller 104 are the same as those before triggering the backup mechanism and then the recovery process is completed. Similar to the backup signal, the recovery signal may be generated by a software method or a hardware method, and not be narrated herein again.

Notably, since no file/data is replicated or moved according to an embodiment of the present invention when executing the recovery process, the data recovery is completed instantaneously, which is different to the conventional technique with more than tens of minutes.

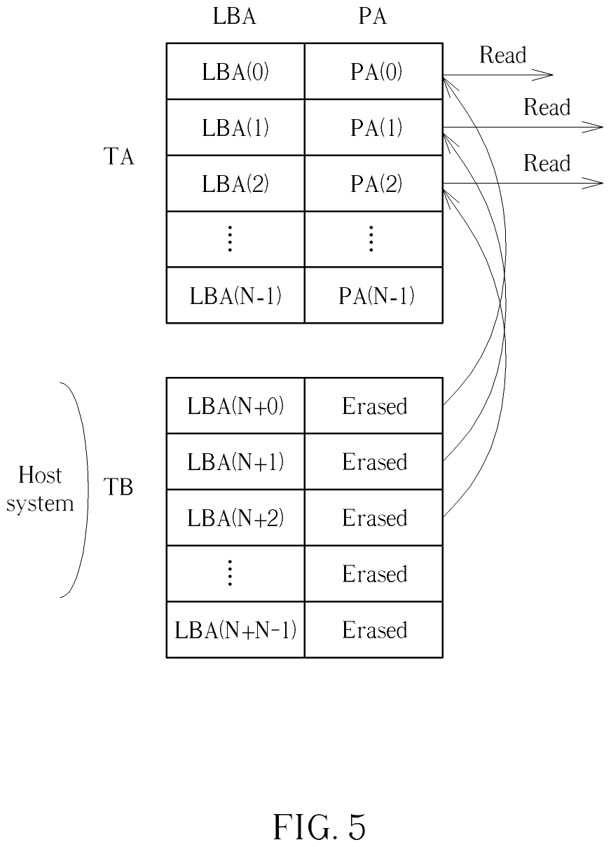

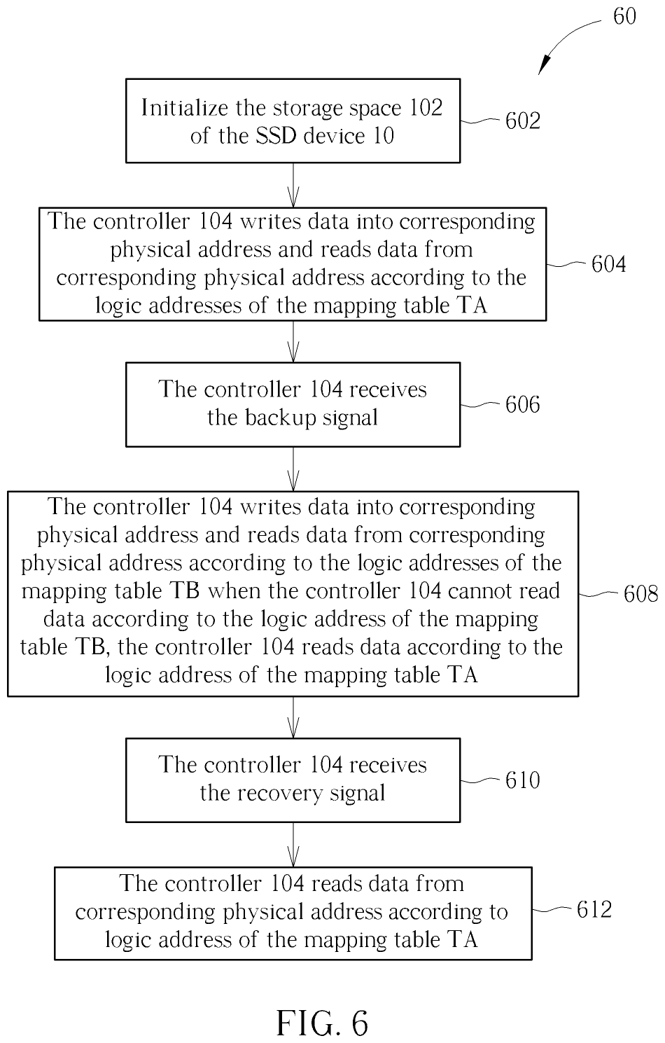

A cyclic backup process of the SSD device 10 may be concluded to a one-time backup and multiple-times recovery method 60, as shown in FIG. 6. The one-time backup and multiple-times recovery method 60 includes the following steps:

Step 602: Initialize the storage space 102 of the SSD device 10;

Step 604: The controller 104 writes data into corresponding physical address and reads data from corresponding physical address according to the logic addresses of the mapping table TA;

Step 606: The controller 104 receives the backup signal;

Step 608: The controller 104 writes data into corresponding physical address and reads data from corresponding physical address according to the logic addresses of the mapping table TB; when the controller 104 cannot read data according to the logic address of the mapping table TB, the controller 104 reads data according to the logic address of the mapping table TA;

Step 610: The controller 104 receives the recovery signal;

Step 612: The controller 104 reads data from corresponding physical address according to logic address of the mapping table TA.

Notably, in step 610, the recovery signal received by the controller 104 may be triggered by a software method or a hardware method, e.g. an indication of recovery mechanism triggered by a user through a third-party software or a button of the SSD device 10 is pressed by the user, such that the controller 104 may receive a pin signal from the general-purpose input/output (GPIO) pin to receive the recovery signal, and not limited thereto.

Moreover, after the controller 104 receives the recovery signal in step 610, data of physical address corresponding to the mapping table TB are erased, and then the erased data are provided by looking up the physical addresses corresponding to the mapping table TA, i.e. goes back to step 608 for iteration, such that one-time backup and multiple-times recovery is achieved. Therefore, the one-time backup and multiple-times recovery method 60 of the SSD device 10 according to an embodiment of the present invention may recover the data in seconds with the complexity of O(1).

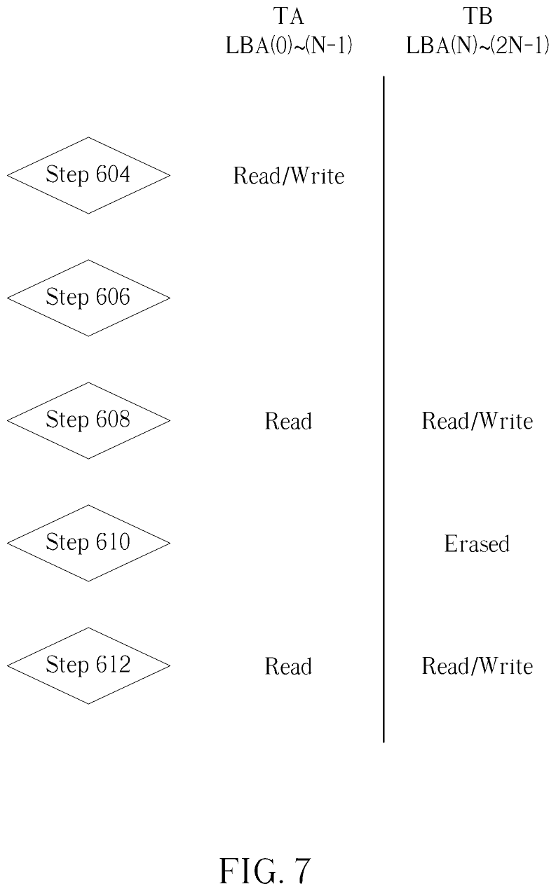

Please refer to FIG. 7, which is a schematic diagram of assignments of the mapping tables TA, TB of the one-time backup and multiple-times recovery method 60 in FIG. 6 according to an embodiment of the present invention. As shown in FIG. 7, in step 604, the controller 104 writes data into corresponding physical address of the mapping table TA and reads data from corresponding physical address of the mapping table TA. In step 606, after the controller 104 receives the backup signal, the controller 104 may write data into corresponding physical address or read data from corresponding physical address according to logic addresses of the mapping table TB in step 608. When the controller 104 cannot read data according to the logic address of the mapping table TB, the controller 104 reads data according to the logic address of the mapping table TA.

Then, when the controller 104 receives the recovery signal in step 610, the controller 104 erases all data corresponding to the mapping table TB. In step 612, the assignment is the same as the step 604, i.e. the controller 104 writes data into corresponding physical address of the mapping table TA and reads data from corresponding physical address of the mapping table TA.

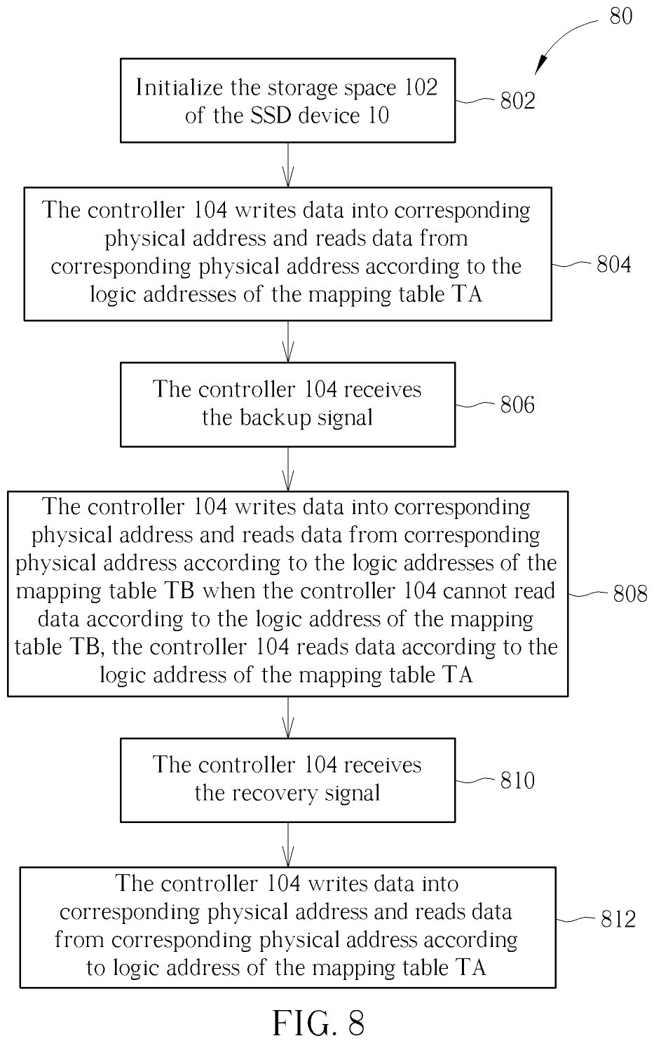

On the other hand, another cyclic backup process of the SSD device 10 may be concluded to a multiple-times backup and multiple-times recovery method 80, as shown in FIG. 8. The multiple-times backup and multiple-times recovery method 80 includes the following steps:
Step 802: Initialize the storage space 102 of the SSD device 10;
Step 804: The controller 104 writes data into corresponding physical address and reads data from corresponding physical address according to the logic addresses of the mapping table TA;
Step 806: The controller 104 receives the backup signal;
Step 808: The controller 104 writes data into corresponding physical address and reads data from corresponding physical address according to the logic addresses of the mapping table TB; when the controller 104 cannot read data according to the logic address of the mapping table TB, the controller 104 reads data according to the logic address of the mapping table TA;
Step 810: The controller 104 receives the recovery signal;
Step 812: The controller 104 writes data into corresponding physical address and reads data from corresponding physical address according to logic address of the mapping table TA.

According to the multiple-times backup and multiple-times recovery method 80, the SSD device 10 according to an embodiment of the present invention may achieve the data recovery in seconds with the complexity of O(1).

Different to the one-time backup and multiple-times recovery method 60, after the controller 104 receives the recovery signal in step 810, the multiple-times backup and multiple-times recovery method 80 goes back to step 804, i.e. the controller 104 writes data into corresponding physical address and reads data from corresponding physical address according to the mapping table TA. Therefore, all data can be provided by corresponding physical addresses of the mapping table TA, i.e. goes back to step 808 for iteration, such that multiple-times backup and multiple-times recovery is achieved.

Notably, the embodiments of the present invention illustrated above may be properly modified by those skilled in the art, and are not limited thereto. For example, the number of mapping tables, and the storage space condition of triggering the backup signal, may all be adjusted according to settings of the user or the SSD device. These modifications are applicable to the present invention.

In summary, the present invention provides a cyclic backup method and a related solid-state disk device, which utilizes conversions of mapping table of logic addresses and physical addresses of the SSD device to achieve rapid data recovery and data backup operations.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A cyclic backup method for a solid-state disk (SSD) device, wherein the SSD device includes a controller and a storage space, the cyclic backup method comprising:
writing, by the controller, data into corresponding physical address and reading data from corresponding physical address according to logic address of a first mapping table;
receiving, by the controller, a backup signal;
writing, by the controller, data into corresponding physical address and reading data from corresponding physical address according to logic address of a second mapping table;
reading, by the controller, a first data according to logic address of the first mapping table when the controller cannot read the first data according to logic address of the second mapping table;
receiving, by the controller, a recovery signal; and
reading, by the controller, data from corresponding physical address according to logic address of the first mapping table;
wherein each logic address of the second mapping table depends on each logic address of the first mapping table.

2. The cyclic backup method of claim 1, wherein after the controller receives the backup signal, the controller is configured to backup data corresponding to physical address of logic address of the first mapping table.

3. The cyclic backup method of claim 1, wherein a capacity of all physical addresses of storage space corresponding to logic addresses of the first mapping table is the same as a capacity of all physical addresses of storage space corresponding to logic addresses of the second mapping table.

4. The cyclic backup method of claim 1, wherein after the controller receives the recovery signal, data corresponding to all physical addresses of logic address of the second mapping table are erased.

5. A cyclic backup method, for a solid-state disk (SSD) device, wherein the SSD device includes a controller and a storage space, the cyclic backup method comprising:
writing, by the controller, data into corresponding physical address and reading data from corresponding physical address according to logic address of a first mapping table;
receiving, by the controller, a backup signal;
writing, by the controller, data into corresponding physical address or reading data from corresponding physical address according to logic address of a second mapping table;
reading, by the controller, a first data according to logic address of the first mapping table when the controller cannot read the first data according to logic address of the second mapping table;
receiving, by the controller, a recovery signal; and
writing, by the controller, data into corresponding physical address and reading data from corresponding physical address according to logic address of the first mapping table;
wherein each logic address of the second mapping table depends on each logic address of the first mapping table.

6. The cyclic backup method of claim 5, wherein after the controller receives the backup signal, the controller is configured to backup data corresponding to physical address of logic address of the first mapping table.

7. The cyclic backup method of claim 5, wherein a capacity of all physical addresses of storage space corresponding to logic addresses of the first mapping table is the same as a capacity of all physical addresses of storage space corresponding to logic addresses of the second mapping table.

8. The cyclic backup method of claim 5, wherein after the controller receives the recovery signal, data corresponding to all physical addresses of logic address of the second mapping table are erased.

9. A solid-state disk (SSD) device, comprising:
a storage space; and
a controller, configured to perform a cyclic backup process according to instructions of a host system, wherein the cyclic backup process comprises:
writing, by the controller, data into corresponding physical address and reading data from corresponding physical address according to logic address of a first mapping table;
receiving, by the controller, a backup signal;
writing, by the controller, data into corresponding physical address and reading data from corresponding physical address according to logic address of a second mapping table;
reading, by the controller, a first data according to logic address of the first mapping table when the controller cannot read the first data according to logic address of the second mapping table;
receiving, by the controller, a recovery signal; and
reading, by the controller, data from corresponding physical address according to logic address of the first mapping table;
wherein each logic address of the second mapping table depends on each logic address of the first mapping table.

10. The SSD device of claim 9, wherein after the controller receives the backup signal, the controller is configured to backup data corresponding to physical address of logic address of the first mapping table.

11. The SSD device of claim 9, wherein a capacity of all physical addresses of storage space corresponding to logic addresses of the first mapping table is the same as a capacity of all physical addresses of storage space corresponding to logic addresses of the second mapping table.

12. The SSD device of claim 9, wherein after the controller receives the recovery signal, data corresponding to all physical addresses of logic address of the second mapping table are erased.

13. A solid-state disk (SSD) device, comprising:
a storage space; and
a controller, configured to perform a cyclic backup process according to instructions of a host system, wherein the cyclic backup process comprises:
writing, by the controller, data into corresponding physical address and reading data from corresponding physical address according to logic address of a first mapping table;
receiving, by the controller, a backup signal;
writing, by the controller, data into corresponding physical address or reading data from corresponding physical address according to logic address of a second mapping table;
reading, by the controller, a first data according to logic address of the first mapping table when the controller cannot read the first data according to logic address of the second mapping table;
receiving, by the controller, a recovery signal; and
writing, by the controller, data into corresponding physical address and reading data from corresponding physical address according to logic address of the first mapping table;
wherein each logic address of the second mapping table depends on each logic address of the first mapping table.

14. The SSD device of claim 13, wherein after the controller receives the backup signal, the controller is configured to backup data corresponding to physical address of logic address of the first mapping table.

15. The SSD device of claim 13, wherein a capacity of all physical addresses of storage space corresponding to logic addresses of the first mapping table is the same as a capacity of all physical addresses of storage space corresponding to logic addresses of the second mapping table.

16. The SSD device of claim 13, wherein after the controller receives the recovery signal, data corresponding to all physical addresses of logic address of the second mapping table are erased.
